(19) United States
(12) Patent Application Publication
(10) Pub. No.: US 2024/0119297 A1
(43) Pub. Date: Apr. 11, 2024

(54) METHOD AND DEVICE WITH CHECKPOINTING

(71) Applicants: SAMSUNG ELECTRONICS CO., LTD., Suwon-si (KR); Seoul National University R&DB Foundation, Seoul (KR)

(72) Inventors: Junyeon LEE, Suwon-si (KR); Jin-soo KIM, Seoul (KR); Seongyeop JEONG, Seoul (KR); Uiseok SONG, Suwon-si (KR); Byungwoo BANG, Suwon-si (KR); Wooseok CHANG, Suwon-si (KR); Hun Seong CHOI, Suwon-si (KR)

(73) Assignees: SAMSUNG ELECTRONICS CO., LTD., Suwon-si (KR); Seoul National University R&DB Foundation, Seoul (KR)

(21) Appl. No.: 18/105,396

(22) Filed: Feb. 3, 2023

(30) Foreign Application Priority Data
Oct. 6, 2022 (KR) 10-2022-0127688

(51) Int. Cl. G06N 3/091; G06N 3/084

(52) U.S. Cl. CPC G06N 3/091; G06N 3/084

(57) ABSTRACT

A processor-implemented method with checkpointing includes: performing an operation for learning of an artificial neural network (ANN) model; and performing a checkpointing to store information about a state of the ANN model, simultaneously with performing the operation for the learning of the ANN model.

### CROSS-REFERENCE TO RELATED APPLICATIONS

This application claims the benefit under 35 USC § 119(a) of Korean Patent Application No. 10-2022-0127688, filed on Oct. 6, 2022 in the Korean Intellectual Property Office, the entire disclosure of which is incorporated herein by reference for all purposes.

### BACKGROUND

### 1. Field

The following description relates to a method and device with checkpointing.

### 2. Description of Related Art

In deep learning, the number of parameters for a model may be large. In particular, a model in natural language processing (NLP) may have hundreds of millions to hundreds of billions of parameters.

Since a significant amount of computational resources may be required to train such a large model, when an ongoing job is stopped due to an unexpected issue, checkpointing and restart functions may be necessary to continue the job from where it was stopped, as opposed to starting the job from the beginning. Checkpointing may refer to storing a current state of a process in a disk, and restart may refer to reconstructing and re-executing the process in a stored state.

The above description has been possessed or acquired by the inventor(s) in the course of conceiving the present disclosure and is not necessarily an art publicly known before the present application is filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method with checkpointing includes: performing an operation for learning of an artificial neural network (ANN) model; and performing a checkpointing to store information about a state of the ANN model, simultaneously with performing the operation for the learning of the ANN model.

The operation for the learning of the ANN model may include a plurality of operation iterations, and each of the plurality of operation iterations may include a forward propagation operation, a backward propagation operation, and a weight update operation.

The performing of the checkpointing may include storing information about a state of the ANN model for a result of performing an operation iteration simultaneously with performing either one or both of a forward propagation operation and a backward propagation operation of a subsequent operation iteration.

The performing of the checkpointing may include determining whether a performing of a checkpointing of a result of performing an operation iteration is completed at a first time point at which a weight update operation of a subsequent operation iteration starts.

The performing of the checkpointing may include stopping the weight update operation of the subsequent operation iteration based on a determination that the performing of the checkpointing of the result of performing the operation iteration is not completed at the first time point.

The performing of the checkpointing may include: obtaining a current storage location of the information about the state of the ANN model; and determining a storage path through the current storage location and the checkpointing based on a target location for storing the information about the state of the ANN model.

The information about the state of the ANN model may include any one or any combination of a parameter and an optimizer of the ANN model.

The performing of the checkpointing may include performing the checkpointing in a unit of layer of the ANN model.

The performing of the checkpointing may include performing the checkpointing of a layer, in which a weight update of an operation iteration is completed, in the unit of layer.

The performing of the operation for the learning of the ANN model may include, while performing a backward propagation operation of a layer of an operation iteration, performing a weight update operation of a another layer of the operation iteration simultaneously.

The performing of the checkpointing may include, while performing the backward propagation operation of the layer of the operation iteration, performing a checkpointing of a another layer of the operation iteration simultaneously.

In another general aspect, one or more embodiments include a non-transitory computer-readable storage medium storing instructions that, when executed by one or more processors, configure the one or more processors to perform any one of, any combination of, or all operations and methods described herein.

In another general aspect, an electronic device includes: a processor configured to: perform an operation for learning of an ANN model; and perform a checkpointing to store information about a state of the ANN model, simultaneously with performing the operation for the learning of the ANN model.

For the performing of the checkpointing, the processor may be configured to store information about a state of the ANN model for a result of performing an operation iteration simultaneously with performing either one or both of a forward propagation operation and a backward propagation operation of a subsequent operation iteration.

For the performing of the checkpointing, the processor may be configured to determine whether a performing of a checkpointing of a result of performing an operation iteration is completed at a first time point at which a weight update operation of a subsequent operation iteration starts.

The processor may be configured to perform the checkpointing in a unit of layer of the ANN model.

For the performing of the operation for the learning of the ANN model, the processor may be configured to simultaneously perform a backward propagation operation of a layer of an operation iteration and a weight update operation of another layer of the operation iteration.

The electronic device may include a memory storing instructions that, when executed by the processor, configure the processor to perform the operation and the checkpointing.

In another general aspect, a processor-implemented method with checkpointing includes: performing a first artificial neural network (ANN) learning operation iteration comprising a forward propagation operation, a backward propagation operation, and a weight update operation; and performing a checkpointing to store information generated by the weight update operation of the first ANN learning operation iteration while performing either one or both of a forward propagation operation and a backward propagation operation of a second ANN learning operation iteration.

The performing of the checkpointing operation may include ending the checkpointing operation prior to a start of a weight update operation of the second ANN learning operation iteration.

Other features and aspects will be apparent from the following detailed description, the drawings, and the claims.

### BRIEF DESCRIPTION OF THE DRAWINGS

FIG. 1A illustrates an example of a deep learning operation method using an artificial neural network (ANN).

FIG. 1B illustrates an example of a learning method and an inference method of an ANN model.

FIG. 2 illustrates an example of performing a checkpointing in a learning process of an ANN model.

FIG. 3 illustrates an example of a learning system of an ANN model.

FIG. 4 illustrates an example of a life cycle of parameters and optimizers in a learning process of an ANN model.

FIGS. 5A and 5B illustrate an example of a lazy checkpointing method.

FIGS. 6A and 6B illustrate an example of a pipelining checkpointing method.

FIGS. 7A to 7D illustrate an example of a checkpointing process.

FIG. 8 illustrates an example of a configuration of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, devices, and/or systems described herein. However, various changes, modifications, and equivalents of the methods, devices, and/or systems described herein will be apparent after an understanding of the disclosure of this application. For example, the sequences of operations described herein are merely examples, and are not limited to those set forth herein, but may be changed with the exception of operations necessarily occurring in a certain order. Also, descriptions of features that are known after understanding of the disclosure of this application may be omitted for increased clarity and conciseness.

Although terms of “first,” “second,” and “third” may be used to describe various components, members, regions, layers, or sections, these components, members, regions, layers, or sections are not to be limited by these terms (e.g., “first,” “second,” and “third”). Rather, these terms are only used to distinguish one component, member, region, layer, or section from another component, member, region, layer, or section. Thus, for example, a “first” component, member, region, layer, or section referred to in examples described herein may also be referred to as a “second” component, member, region, layer, or section, and a “second” component, member, region, layer, or section referred to in examples described herein may also be referred to as the “first” component without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there may be no other elements intervening therebetween. Likewise, similar expressions, for example, “between” and “immediately between,” and “adjacent to” and “immediately adjacent to,” are also to be construed in the same.

The singular forms “a,” “an,” and “the” are intended to include the plural forms as well, unless the context clearly indicates otherwise. It should be further understood that the terms “comprises/comprising” and/or “includes/including,” when used in this specification, specify the presence of stated features, integers, steps, operations, elements, components and/or combinations thereof, but do not preclude the presence or addition of one or more other features, integers, steps, operations, elements, components, and/or combinations thereof. As used herein, the term “and/or” includes any one and any combination of any two or more of the associated listed items. The use of the term “may” herein with respect to an example or embodiment (for example, as to what an example or embodiment may include or implement) means that one or more examples or embodiments exists where such a feature is included or implemented, while all examples are not limited thereto.

Unless otherwise defined, all terms used herein including technical or scientific terms have the same meaning as commonly understood consistent with and after an understanding of the present disclosure. It will be further understood that terms, such as those defined in commonly-used dictionaries, should be interpreted as having a meaning that is consistent with their meaning in the context of the relevant art and the present disclosure, and will not be interpreted in an idealized or overly formal sense unless expressly so defined herein.

The examples may be implemented as various types of products, such as, for example, a personal computer (PC), a laptop computer, a tablet computer, a smartphone, a television (TV), a smart home appliance, an intelligent vehicle, a kiosk, and/or a wearable device. Hereinafter, examples will be described in detail with reference to the accompanying drawings. In the drawings, like reference numerals are used for like elements.

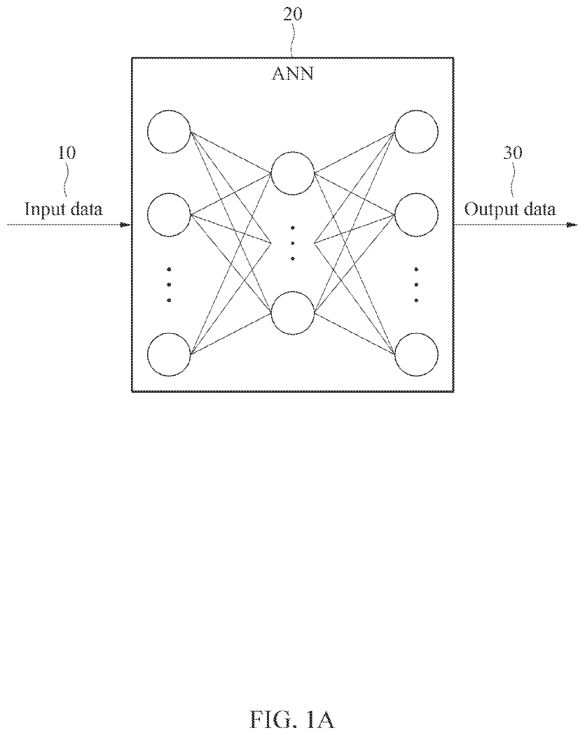

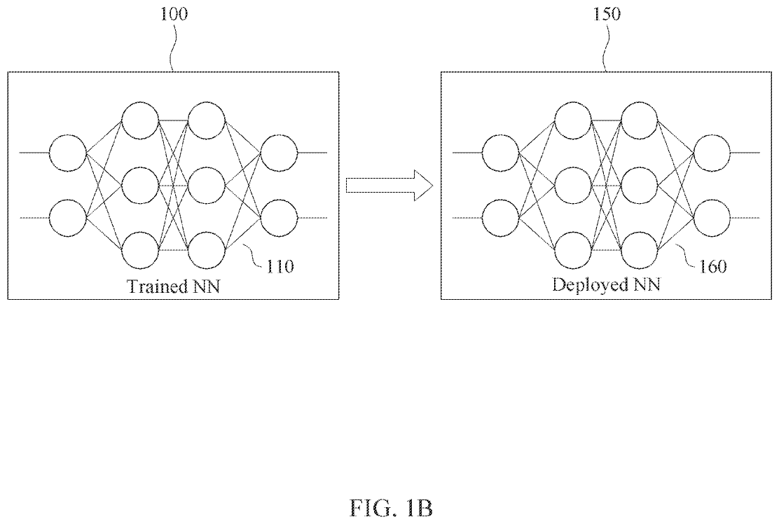

FIG. 1A illustrates an example of a deep learning operation method using an artificial neural network (ANN).

An artificial intelligence (AI) algorithm, including deep learning or the like, is characterized as providing input data 10 to an ANN and learning output data 30 through an operation such as a convolution. The ANN may be a computational architecture obtained by modeling. In the ANN, nodes may be connected to each other and collectively operate to process input data. Various types of neural networks may include, for example, a convolutional neural network (CNN), a recurrent neural network (RNN), a deep belief network (DBN), or a restricted Boltzmann machine (RBM), but are not limited thereto. In a feed-forward neural network, nodes may have links to other nodes. Such links may extend through the neural network in one direction, for example, in a forward direction. While the network may be referred to as an “artificial neural network”, such reference is not intended to impart any relatedness with respect to how the network computationally maps or thereby intuitively recognizes information and how a biological brain operates. I.e., the term “artificial neural network” is merely a term of art referring to the hardware-implemented network.

FIG. 1A illustrates a structure in which the input data 10 is provided to the ANN and the output data 30 is produced through an ANN (e.g., a CNN 20) including one or more layers. The ANN may be, for example, a deep neural network including two or more layers.

The CNN 20 may be used to extract “features”, for example, a border, a line, and a color from the input data 10. The CNN 20 may include a plurality of layers. Each of the layers may receive data, process data input to a corresponding layer, and generate data that is to be output from the corresponding layer. Data output from a layer may be a feature map generated by performing a convolution operation of an image or a feature map that is input to the CNN 20 and weight values of one or more filters (e.g., the filters 110-1 to 110-n discussed below). Initial layers of the CNN 20 may operate to extract features of a relatively low level, for example, edges or gradients, from an input. Subsequent layers of the CNN 20 may extract gradually more complex features such as the eyes and nose in an image.

FIG. 1B illustrates an example of a learning method and an inference method of an ANN model.

Referring to FIG. 1B, a learning system of an ANN model may include a training device 100 and an inference device 150. The training device 100 may be a computing device having various processing functions, such as generating a neural network, training or learning a neural network, or retraining a neural network. For example, the training device 100 may be implemented as various devices, such as a PC, a server device, or a mobile device.

The training device 100 may generate one or more trained neural networks 110 by repetitively training or learning a given initial neural network. The generating of the one or more trained neural networks 110 may refer to determining neural network parameters. In this case, the neural network parameters may include various types of data, such as input/output activations, weights, and biases that are input to and output from a neural network. When the neural network is repeatedly trained, the parameters of the neural network may be tuned to calculate a more accurate output for a given input.

The training device 100 may transmit the one or more trained neural networks 110 to the inference device 150. The inference device 150 may include, be, or be included in, for example, a mobile device and/or an embedded device. The inference device 150 may be a piece of hardware dedicated for driving a neural network and may be an electronic device including any one or any combination of any two or more of a processor (e.g., one or more processors), a memory (e.g., one or more memories), an input/output (I/O) interface, a display, a communication interface, and a sensor.

The inference device 150 may be or include all digital devices that have a memory element and a microprocessor and have an operational capability, such as a tablet PC, a smartphone, a PC (e.g., a laptop computer), an AI speaker, a smart TV, a mobile phone, a navigation, a web pad, a personal digital assistant (PDA), and/or a workstation.

The inference device 150 may drive the one or more trained neural networks 110 without any change or may drive a neural network 160 to which the one or more trained neural networks 110 are processed (e.g., quantized). The inference device 150 for driving the neural network 160 may be implemented in a separate device from the training device 100. However, there is no limitation thereto, and the inference apparatus 150 may also be implemented in the same device as the training device 100.

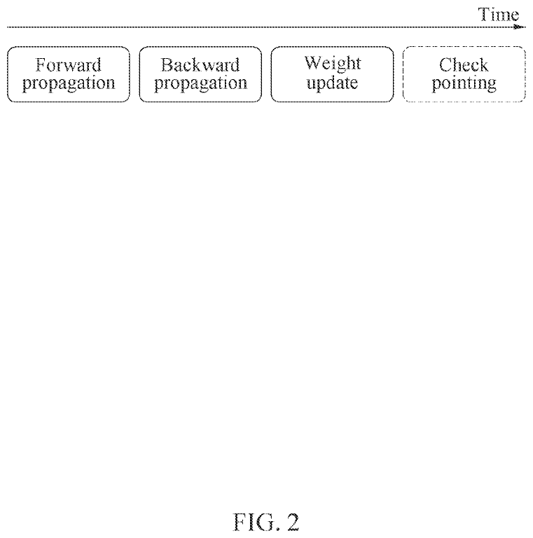

FIG. 2 illustrates an example of performing a checkpointing in a learning process of an ANN model.

Referring to FIG. 2, learning of an ANN model may include calculating and determining a weight and a bias to minimize a difference between a final output value and an actual value. Learning of the ANN model according to an example may include a forward propagation, a backward propagation, and a weight update.

Forward propagation may refer to calculating (e.g., determining) and storing variables sequentially from an input layer to an output layer of the ANN model. Backward propagation may refer to a method of calculating gradients of parameters of the ANN model. In backward propagation, gradients of intermediate variables and parameters of an objective function related to each layer of the ANN model may be calculated and stored in an order from the output layer to the input layer of the ANN model. Weight update may refer to replacing an existing weight with a weight determined through backward propagation. A process of learning through the forward propagation, the backward propagation, and the weight update may be performed iteratively; for example, when an ANN model is trained by repeating the iteration 10 times, the iteration of the ANN model may be 10.

Learning of an ANN model according to an example may further include a checkpointing. Since a significant amount of computational resources may be used to train an ANN model, when a job is interrupted by an unexpected problem in a processor, a checkpointing function and a restart function may be implemented in response to the problem.

A checkpointing according to an example may refer to storing an intermediate state of a training model in a storage device (e.g., a solid state drive (SSD) and/or a hard disk drive (HDD)), and the time for checkpointing may be proportional to an I/O time and a size of the training model. A restart according to an example may refer to a function of reconstructing and re-executing a stored ANN model using the stored intermediate state.

In order to save a state of an ANN model in the storage device, all processes must stop computations at regular intervals. Even when the state of the ANN model is stored by an optimal checkpointing cycle, in a typical checkpointing method, overhead associated with checkpointing may occupy a large part of the overall learning process.

In contrast, a checkpointing method according to one or more embodiments may optimize checkpointing time by considering a life cycle of data stored during a checkpointing step, examples of which are described below. A checkpointing step according to one or more embodiments may not be performed in every iteration, but may be performed only once in every tens or hundreds of iterations. A typical checkpointing technique may perform checkpointing after sequentially executing a forward propagation step, a backward propagation step, and a weight update step. In contrast, a checkpointing method according to one or more embodiments may reduce checkpointing overhead by analyzing the life cycle of data stored in the ANN model.

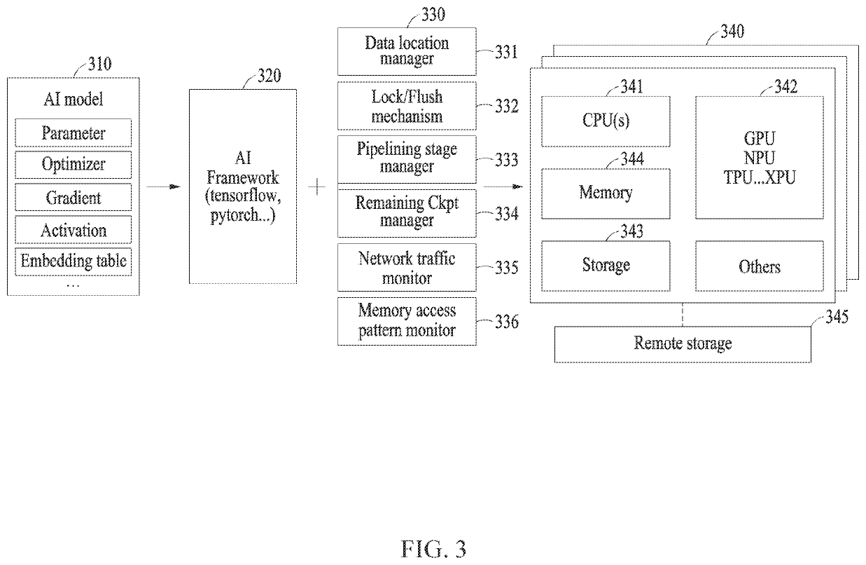

FIG. 3 illustrates an example of a learning system of an ANN model.

Referring to FIG. 3, a learning system of an ANN model according to an example may include an ANN model 310, an ANN model framework 320, a checkpointing device 330, and a training device 340.

The ANN model 310 according to one or more embodiments increases an accuracy of the ANN model 310 by updating information about a state of components of the ANN model 310 (e.g., parameters, embedding tables, optimizer states, and the like of the ANN model 310) in the training device 340, which includes a central processing unit (CPU), a graphics processing unit (GPU), and/or a network processing unit (NPU), based on the ANN model framework 320, such as Pytorch and/or Tensorflow.

The training device 340 for training the ANN model 310 may include one or a plurality of systems, and a part of each system may include processors 341 and 342, such as a CPU, a GPU, and an NPU, a storage 343, memory 344, and the like. In addition, the training device 340 according to an example may include the storage 343 physically connected to the training device 340 in a node and a remote storage 345 connected by a network and so on.

Information about the state of the components of the ANN model 310 may exist in the memory 344, the storage 343, and/or the remote storage 345 during a learning process and may be used in the processors 341 and 342 during the learning process, and a value of the information about the state of the components of the ANN model 310 may be modified. The modified information about the state of the components of the ANN model 310 may be stored in the storage 343 and/or the remote storage 345 regularly or irregularly. The entire information about the state of the components of the ANN model 310 may be stored in a form of a new file, only a differential may be stored, and/or an incremental may be stored.

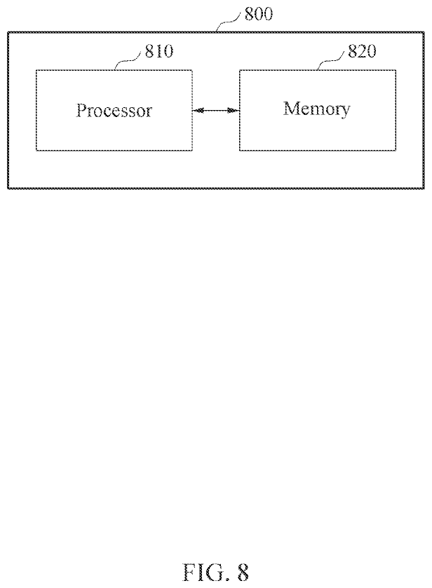

The checkpointing device 330 according to an example may include a data location manager 331, a lock/flush manager 332, a pipelining stage manager 333, a remaining checkpointing manager 334, a network traffic monitor 335, and a memory access pattern monitor 336. The checkpointing device 330 may be included in the training device 340, the training device 340 may be included in the checkpointing device 330, or the checkpointing device 330 and the training device 340 may both be included in a larger device (e.g., an electronic device 800 of FIG. 8), according to non-limiting examples.

The data location manager 331 according to an example may manage where the information about the state of the components of the ANN model 310 is to be stored in the training device 340. The data location manager 331 may be aware of or may determine a bandwidth between a target space for storing a checkpointing and a space for storing the information about the state of the components of the ANN model 310, and may use a path, in which a highest bandwidth between the target space and the space for storing the information about the state of the components of the ANN model 310 is available, to store a checkpointing file.

The lock/flush manager 332 according to an example may compare whether a weight update of an N+1st iteration is started to whether a checkpointing of an Nth iteration is complete. When the weight update of the N+1st iteration starts when the checkpointing of the previous Nth iteration is not complete, the lock/flush manager 332 may stop the weight update step of the N+1st iteration and may quickly complete the checkpointing of the Nth iteration.

The pipelining stage manager 333 according to an example may manage a 2-stage pipeline or a 3-stage pipeline depending on whether a checkpointing is performed in a training process of an ANN model. The pipelining stage manager 333 may operate as a 3-stage pipeline of backward propagation of a forward propagation (e.g., stage 1), a backward propagation (e.g., stage 2), and a checkpointing (e.g., stage 3) in an iteration in which the checkpointing according to an example is determined to be performed (e.g., determined to be necessary), and may operate as a 2-stage pipeline of a backward propagation (e.g., stage 1) and a weight update (e.g., stage 2) in an iteration in which checkpointing is determined to not be performed (e.g., determined to be unnecessary).

The remaining checkpointing manager 334 according to an example may enable a forward propagation path of a next iteration to proceed regardless of whether a checkpointing of a previous iteration is completed. The remaining checkpointing manager 334 may enable a checkpointing which has not been completed in a previous iteration to be stored in a backward propagation while a forward propagation of a next iteration is ongoing. The remaining checkpointing manager 334 may be implemented simultaneously with or separately from the lock/flush manager 332.

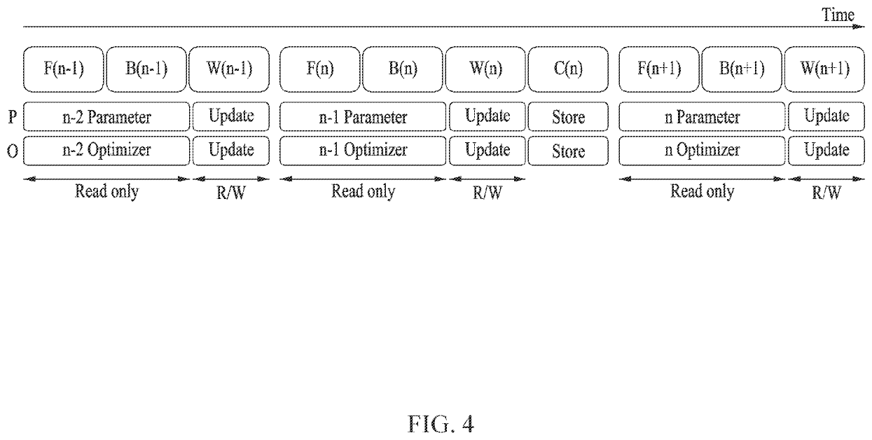

FIG. 4 illustrates an example of a life cycle of parameters and optimizers in a learning process of an ANN model.

Referring to FIG. 4, states of parameters and optimizers in a forward propagation F step, a backward propagation B step, a weight update W step, and a checkpointing C step of an N−1st iteration, an Nth iteration, and an N+1st iteration are shown.

When a checkpointing is stored in an Nth iteration, I/O time is consumed to store a checkpointing file of the checkpointing. However, items stored in the Nth iteration are N parameters and N optimizers generated after an Nth weight update, and the N parameters and the N optimizers may not be modified until a weight update step of the next N+1st iteration. That is, until a next modification of each piece of data, the integrity of the data is guaranteed, which means that a checkpointing may be performed at a time point of a forward propagation and a backward propagation of a next iteration (e.g., the N+1st iteration). Hereinafter, performing a checkpointing at a time point of a forward propagation and a backward propagation of a next iteration (e.g., the N+1st iteration) may be referred to as lazy checkpointing.

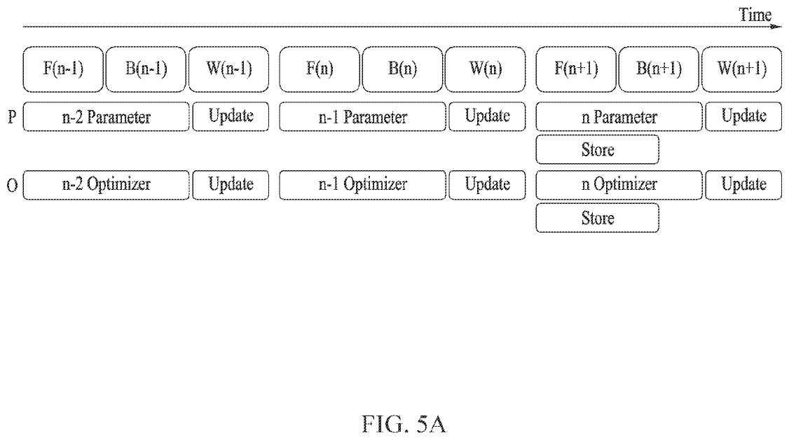

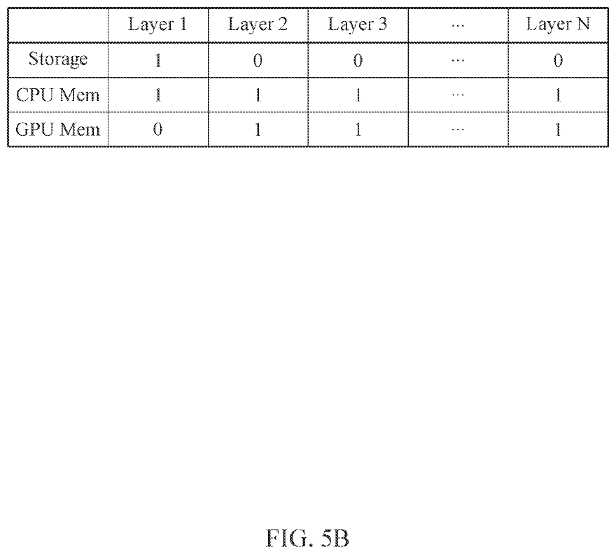

FIGS. 5A and 5B illustrate an example of a lazy checkpointing method.

Referring to FIG. 5A, a lazy checkpointing according to an example may refer to hiding and processing a checkpointing during either one or both of the forward propagation and the backward propagation of the N+1st iteration, not after the weight update of the Nth iteration but before either one or both of the forward propagation and the backward propagation of the N+1st iteration. The description provided with reference to FIGS. 1A to 4 may be applied and incorporated to FIGS. 5A and 5B, and thus, a duplicate description may be omitted.

In the forward propagation and the backward propagation steps of the N+1st iteration, values of parameters and optimizers (e.g., values of parameters and optimizers determined in the Nth iteration) are not modified and the data of the values of parameters and optimizers is only read; and such data modification is performed in the weight update step of the N+1st iteration. Therefore, a checkpointing according to an example may be performed before the weight update of the N+1st iteration.

According to an example, there may be one or multiple copies of the data of the values of parameters and optimizers at a specific time point across a storage, CPU memory, and GPU memory. A lazy checkpointing according to an example may be performed by a data location manager (e.g., the data location manager 331 of FIG. 3) which manages a location of such data and by a lock/flush manager (e.g., the lock/flush manager 332 of FIG. 3) which processes locks and flushes of data before a time point of the weight update of the N+1st iteration. Hereinafter, a data location manager according to an example may be referred to as a location management thread.

Referring to FIG. 5B, a location management thread according to an example may monitor a movement of data of parameters and optimizers, and may manage a current location of the data of parameters and optimizers in a bitmap form or an address form. Each piece of data may be located in locations such as a storage, CPU memory, and/or GPU memory, and may exist in multiple locations simultaneously. Therefore, the location management thread may be aware of and optimize a nearest (or fastest) location for storing data of parameters or optimizers in a storage.

The lock/flush manager according to an example may manage whether a checkpointing is completed up to a start of the weight update time point of the N+1st iteration, at which point a checkpointing time of the Nth iteration takes too long (e.g., a checkpointing time of the Nth iteration that continues past the start of the weight update time point of the N+1st iteration may result in storing data that has lost integrity in the checkpointing of the Nth iteration, as such data may be modified by the weight update of the N+1st iteration). The lock/flush manager may do so because when the weight update of the N+1st iteration starts even though the checkpointing of the Nth iteration is not completed, values of parameters or optimizers may be modified.

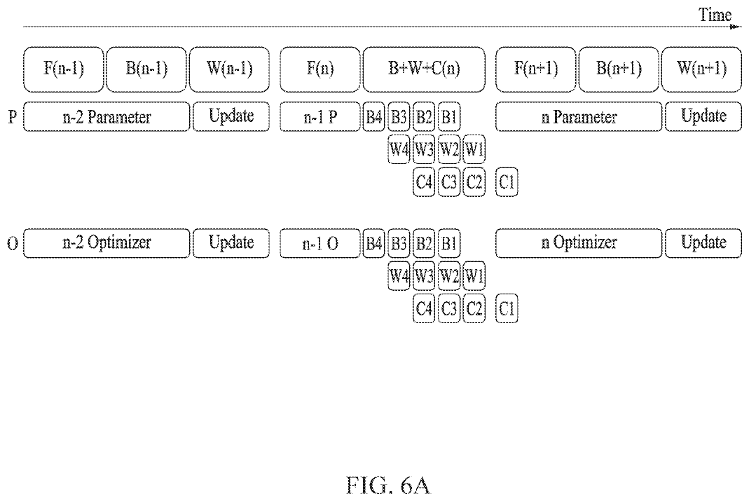

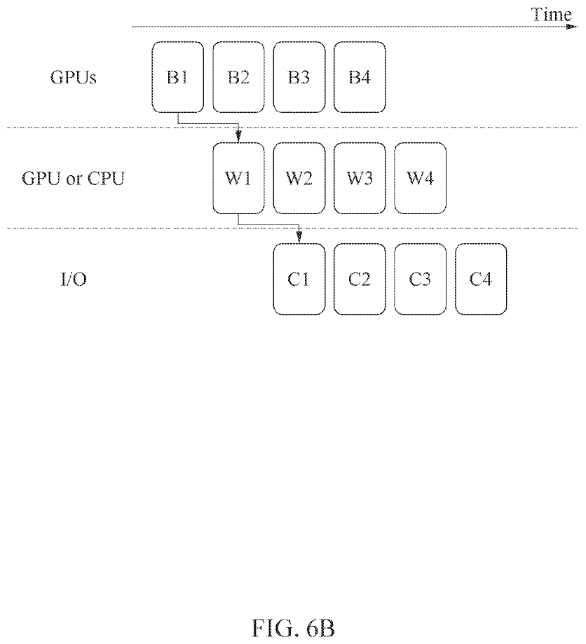

FIGS. 6A and 6B illustrate an example of a pipelining checkpointing method.

In a typical checkpointing method, a backward propagation may first be performed for all layers, then a weight update may be performed for all layers, and finally, parameters and optimizers of all layers may be stored.

A pipelining checkpointing according to an example may refer to performing a checkpointing by dividing a backward propagation step, a weight update step, and a checkpointing step into a unit of layer.

A pipelining stage manager (e.g., the pipelining stage manager 333 of FIG. 3) according to an example may perform a checkpointing for a layer in which a weight update of a corresponding iteration is complete, by a unit of layer. For example, the pipelining stage manager may directly perform a weight update of a last layer in which a backward propagation is completed first and store data of parameters and optimizers of which the weight update is completed.

Referring to FIG. 6A, the pipelining stage manager according to an example may enable a performance of a backward propagation operation (e.g., B3) of a Kth layer (e.g., a second layer) of an Nth operation iteration simultaneously with a weight update operation (e.g., W4) of a K+1st layer (e.g., a third layer) of the Nth operation iteration. In addition, the pipelining stage manager according to an example may enable checkpointing (e.g., C4) of a K+2nd layer (e.g., a 4th layer) of the Nth operation iteration at the same time.

Referring to FIG. 6B, the pipelining stage manager according to an example may enable checkpointing to be performed in a unit of layer of an ANN model. For example, when an ANN model with 12 layers performs model parallel training with 4 GPUs, a pipelining may be performed in a unit of 3 layers.

In a model training process, a checkpointing may not be performed in every iteration. Therefore, when a checkpointing is not performed, a model training may be performed in a 2-stage pipeline of a backward propagation and a weight update, and for an iteration with checkpointing, a 3-stage pipelining of a backward propagation, a weight update, and a checkpointing may be performed. The pipelining stage manager according to an example may manage whether to perform a checkpointing, pipelining stage management for each layer, and so on.

A remaining checkpointing manager according to an example may manage a checkpointing step that is not yet completed even though a backward propagation step and a weight update step are completed. For example, when a GPU and a CPU wait until step C4 in FIG. 6B is completed, the GPU and CPU resources may be left in an idle state. In order to minimize idle resources, the remaining checkpointing manager according to an example may perform a forward propagation of a next learning iteration simultaneously with performing step C4.

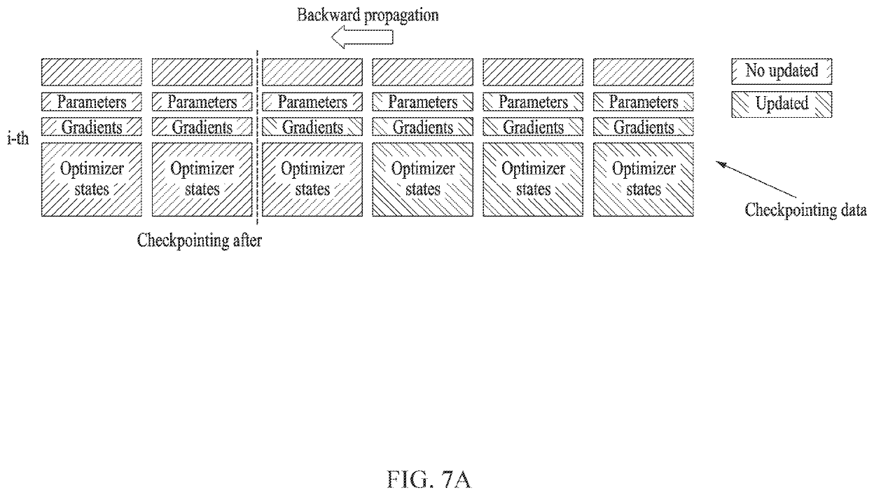

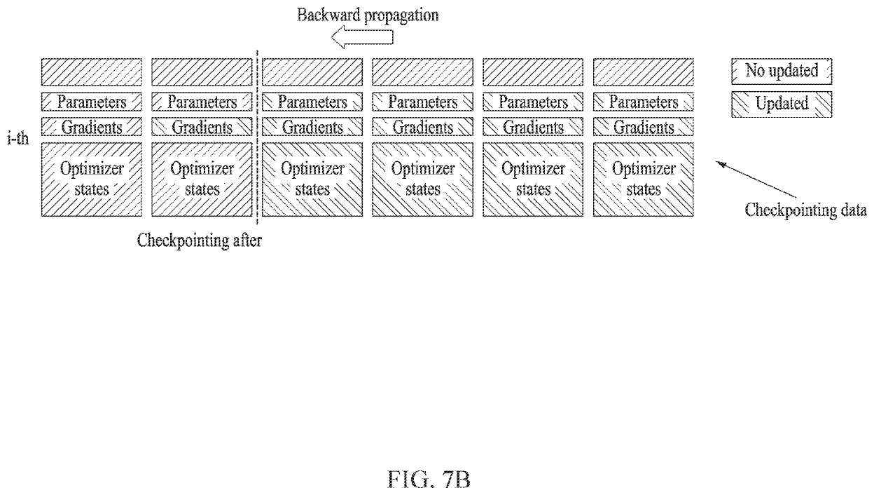

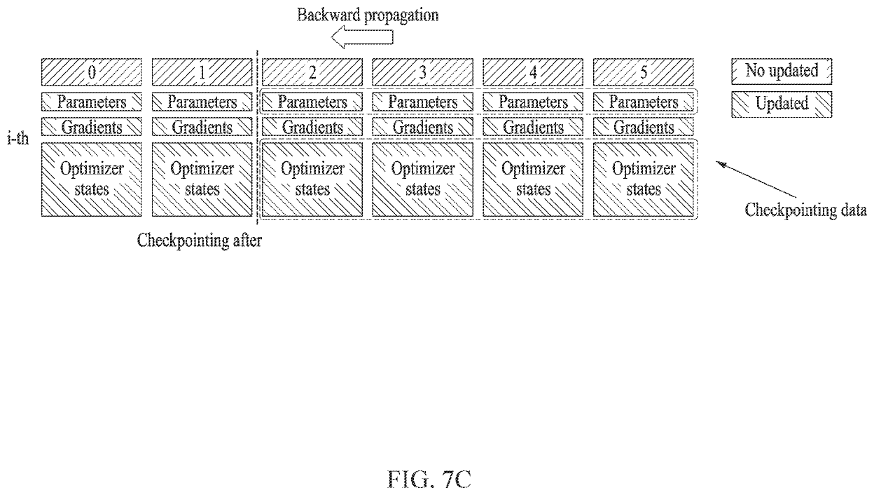

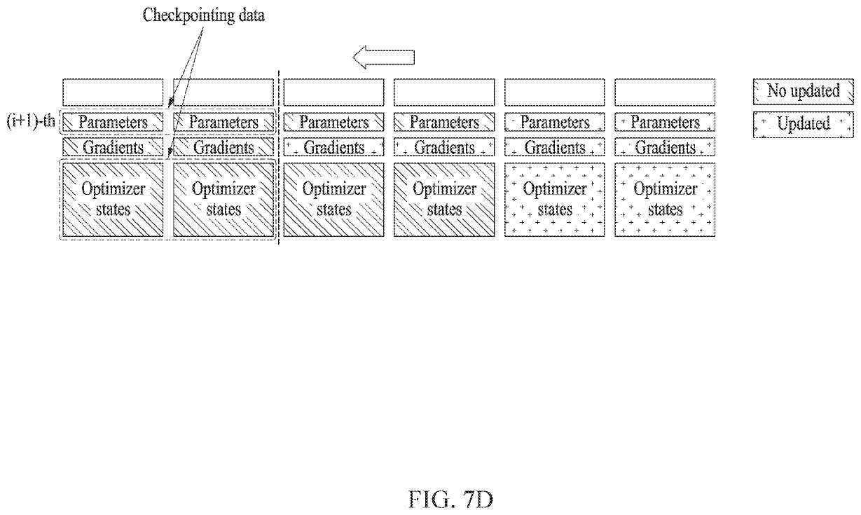

FIGS. 7A to 7D illustrate an example of a checkpointing process.

Referring to FIG. 7A, a checkpointing device (e.g., the checkpointing device 330) according to an example may, in a backward propagation process of an i-th iteration, update gradients of a corresponding GPU, and then update information about a state of a specific part (e.g., optimizers and parameters).

Referring to FIGS. 7B and 7C, for a GPU in which information about a state of an ANN model (e.g., optimizers and parameters) is updated in an i-th iteration, asynchronous checkpointing of the information about the state of the ANN model (e.g., optimizers and parameters) may be performed.

Referring to FIG. 7D, in a backward propagation process of an i+1st iteration, for information about a state of an ANN model (e.g., optimizers and parameters) of which a checkpointing is not performed in a previous step, asynchronous checkpointing may be performed.

After gradients are updated in a backward propagation process of an ANN model, information about a state of the ANN model (e.g., optimizers and parameters) is updated, and checkpointing may be performed immediately after the information about the state of the ANN model (e.g., optimizers and parameters) is updated.

A checkpointing and a weight update may be performed simultaneously with a backward propagation process of a previous layer, and pipelining of the checkpointing and the weight update may be performed as much as the dimensions of model parallelism.

In addition, in a process of storing a checkpointing of an Nth iteration, the checkpointing of the Nth iteration may be continued even when a forward propagation process of an N+1st iteration starts. This is because parameters and optimizers are not modified in the forward propagation process of the N+1st iteration.

FIG. 8 illustrates an example of a configuration of an electronic device.

Referring to FIG. 8, an electronic device 800 according to an example may include a processor 810 (e.g., one or more processors) and a memory 820 (e.g., one or more memories). The electronic device 800 may be or include the training device 100 of FIG. 1B, the inference device 150 of FIG. 1B, the checkpointing device 330 of FIG. 3, and/or the training device 340 of FIG. 3.

The memory 820 may store computer-readable instructions. When the computer-readable instructions stored in the memory 820 are executed by the processor 810, the processor 810 may process operations defined by the computer-readable instructions. The memory 820 may include, for example, random access memory (RAM), dynamic random access memory (DRAM), static random access memory (SRAM), or other types of non-volatile memory known in the art. The memory 820 may store a pre-trained ANN model. The memory 820 may store instructions that, when executed by the processor 810, configure the processor 810 to perform any one, any combination of any two or more of, or all operations and methods described above with respect to FIGS. 1 to 7.

The processor 810 according to an example may control the overall operation of the electronic device 800. The processor 810 may be a hardware-implemented device having a circuit that is physically structured to execute desired operations. The desired operations may include instructions or code included in a program. The hardware-implemented device may include, for example, a microprocessor, a CPU, a GPU, a processor core, a multi-core processor, a multiprocessor, an application-specific integrated circuit (ASIC), a field programmable gate array (FPGA), and/or an NPU.

The processor 810 according to an example may control the electronic device 800 by executing functions and instructions for execution in the electronic device 800.

The electronic device 800 may perform an operation of learning an ANN model and simultaneously perform a checkpointing by which information about a state of the ANN model is stored, through control of the processor 810 according to an example.

The training devices, inference devices, checkpointing devices, data location managers, lock/flush managers, pipelining stage managers, remaining checkpointing managers, network traffic monitors, training devices, processors, storages, memories, remote storages, electronic devices, training device 100, inference device 150, checkpointing device 330, data location manager 331, lock/flush manager 332, pipelining stage manager 333, remaining checkpointing manager 334, network traffic monitor 335, training device 340, processors 341 and 342, storage 343, memory 344, remote storage 345, electronic device 800, processor 810, memory 820, memory access pattern monitor 336, and other apparatuses, units, modules, devices, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method with checkpointing, the method comprising:
performing an operation for learning of an artificial neural network (ANN) model; and
performing a checkpointing to store information about a state of the ANN model, simultaneously with performing the operation for the learning of the ANN model.

2. The method of claim 1, wherein
the operation for the learning of the ANN model comprises a plurality of operation iterations, and
each of the plurality of operation iterations comprises a forward propagation operation, a backward propagation operation, and a weight update operation.

3. The method of claim 1, wherein the performing of the checkpointing comprises storing information about a state of the ANN model for a result of performing an operation iteration simultaneously with performing either one or both of a forward propagation operation and a backward propagation operation of a subsequent operation iteration.

4. The method of claim 1, wherein the performing of the checkpointing comprises determining whether a performing of a checkpointing of a result of performing an operation iteration is completed at a first time point at which a weight update operation of a subsequent operation iteration starts.

5. The method of claim 4, wherein the performing of the checkpointing comprises stopping the weight update operation of the subsequent operation iteration based on a determination that the performing of the checkpointing of the result of performing the operation iteration is not completed at the first time point.

6. The method of claim 1, wherein the performing of the checkpointing comprises:
obtaining a current storage location of the information about the state of the ANN model; and
determining a storage path through the current storage location and the checkpointing based on a target location for storing the information about the state of the ANN model.

7. The method of claim 1, wherein the information about the state of the ANN model comprises any one or any combination of a parameter and an optimizer of the ANN model.

8. The method of claim 1, wherein the performing of the checkpointing comprises performing the checkpointing in a unit of layer of the ANN model.

9. The method of claim 8, wherein the performing of the checkpointing comprises performing the checkpointing of a layer, in which a weight update of an operation iteration is completed, in the unit of layer.

10. The method of claim 1, wherein the performing of the operation for the learning of the ANN model comprises, while performing a backward propagation operation of a layer of an operation iteration, performing a weight update operation of a another layer of the operation iteration simultaneously.

11. The method of claim 10, wherein the performing of the checkpointing comprises, while performing the backward propagation operation of the layer of the operation iteration, performing a checkpointing of a another layer of the operation iteration simultaneously.

12. A non-transitory computer-readable storage medium storing instructions that, when executed by a processor, configure the processor to perform the method of claim 1.

13. An electronic device comprising:
a processor configured to:
perform an operation for learning of an ANN model; and
perform a checkpointing to store information about a state of the ANN model, simultaneously with performing the operation for the learning of the ANN model.

14. The electronic device of claim 13, wherein, for the performing of the checkpointing, the processor is configured to store information about a state of the ANN model for a result of performing an operation iteration simultaneously with performing either one or both of a forward propagation operation and a backward propagation operation of a subsequent operation iteration.

15. The electronic device of claim 13, wherein, for the performing of the checkpointing, the processor is configured to determine whether a performing of a checkpointing of a result of performing an operation iteration is completed at a first time point at which a weight update operation of a subsequent operation iteration starts.

16. The electronic device of claim 13, wherein the processor is configured to perform the checkpointing in a unit of layer of the ANN model.

17. The electronic device of claim 13, wherein, for the performing of the operation for the learning of the ANN model, the processor is configured to simultaneously perform a backward propagation operation of a layer of an operation iteration and a weight update operation of another layer of the operation iteration.

18. The electronic device of claim 13, further comprising a memory storing instructions that, when executed by the processor, configure the processor to perform the operation and the checkpointing.

19. A processor-implemented method with checkpointing, the method comprising:
performing a first artificial neural network (ANN) learning operation iteration comprising a forward propagation operation, a backward propagation operation, and a weight update operation; and
performing a checkpointing to store information generated by the weight update operation of the first ANN learning operation iteration while performing either one or both of a forward propagation operation and a backward propagation operation of a second ANN learning operation iteration.

20. The method of claim 19, wherein the performing of the checkpointing operation comprises ending the checkpointing operation prior to a start of a weight update operation of the second ANN learning operation iteration.
